(19) United States
(12) Patent Application Publication
(10) Pub. No.: US 2024/0377807 A1
(43) Pub. Date: Nov. 14, 2024

(54) Control System and Method for Controlling an Apparatus or System

(71) Applicant: Siemens Aktiengesellschaft, Muenchen (DE)

(72) Inventors: Matthias FRANK, Erlangen (DE); Alexander STEIN, Veitsbronn (DE); Christoph HORN, Heroldsberg (DE); Michael BAIERLEIN, Spalt (DE); Dominik BUDDAY, Erlangen (DE)

(21) Appl. No.: 18/656,777

(22) Filed: May 7, 2024

(30) Foreign Application Priority Data
May 11, 2023 (EP) 23172923

(51) Int. Cl. G05B 19/4063

(52) U.S. Cl. CPC G05B 19/4063; G05B 2219/50185

(57) ABSTRACT

A method and control system for controlling an apparatus or system, wherein at least one safety function is provided with regard to the control of the apparatus or system, where the at least one safety function has at least one safety sub-function, the control system comprises a first safety-oriented controller and a second safety-oriented controller, the first safety-oriented controller and the second safety-oriented controller are communicatively coupled via a safety-oriented communication link, the first safety-oriented controller is configured to perform the at least one safety function, and the second safety-oriented controller function as a processor and is configured to perform the at least one safety sub-function using input data received via the safety-oriented communication link from the first safety-oriented controller.

### BACKGROUND OF THE INVENTION

### 1. Field of the Invention

The invention relates to a method and control system for controlling an apparatus or system, where at least one safety function is provided with regard to the control of the apparatus or system.

### 2. Description of the Related Art

The use of fail-safe control systems in industrial automation technology is widespread, with typical applications such as safe interlocking or monitoring of limit values. However, the development toward efficient and, at the same time, flexible production also increases the requirements on safety programs and the safe monitoring of such dynamic processes and systems in real time requires more complex safety solutions.

Conventional solutions are known in which Coded Processing is used for the purpose of meeting safety requirements. In these, safety-oriented processing steps are performed in two diversified paths using coded data and operations, which eliminates hardware redundancy while also providing solution consistency and scalability.

In addition, “lockstep processors” are known. With regard to logical processing, lockstep processors usually offer a cost-effective variant for achieving on-chip redundancy through their intrinsic multi-core architecture and suitable processing and comparison mechanisms.

WO 2016/138956 A1 discloses system in which program parts that cannot be processed in a coded form must be processed in hardware redundancy. This requires two processor units for the non-coded execution.

### SUMMARY OF THE INVENTION

In view of the foregoing, it is an object of the present invention to improve fail-safe and high-performance processing of programs with complex safety requirements.

This and other objects and advantages are achieved in accordance with the invention by a control system for controlling an apparatus or system, where at least one safety function is provided with regard to the control of the apparatus or system, where the at least one safety function has at least one safety sub-function, where the control system comprises a first safety-oriented control device and a second safety-oriented control device, where the first safety-oriented control device and the second safety-oriented control device are communicatively coupled via a safety-oriented communication link, where the first safety-oriented control device is configured to execute the at least one safety function, and where the second safety-oriented control device is based on a processor unit and is configured to execute the at least one safety sub-function using input data received via the safety-oriented communication link from the first safety-oriented control device.

A safety-oriented control device according to the terminology of the present application is configured so as to guarantee as far as possible that no dangerous state (for example, due to a failure of a component) can arise during operation of the safety-oriented control device. A safety-oriented control device may additionally be configured such that no unacceptable risk can arise from the apparatus or system during the operation of the safety-oriented control device.

In accordance with the present disclosure, a safety function is understood to mean a function that must satisfy safety-oriented criteria so that the system on which the safety function is executed becomes a safety-oriented system. These criteria are defined or standardized, for example, via safety specifications. For example, requirements must be met that define the initiation of stop operations, the observance of distances to zone boundaries, etc. In particular, the safety standards International Electrotechnical Commission (IEC) standard 61508, International Organization for Standardization (ISO) standard 10218 are applicable, which must be observed depending on the application. A safety-oriented function of the controller refers, in particular, to a stopping or braking function executed in a safety-oriented manner.

In addition, safety functions must be established such that “functional safety” is guaranteed, i.e., such that system or component failures or faults are discovered and lead to the apparatus or system being brought to a safe state. In addition to the processing or calculation or verification of values for generating output values of the controller, a functionally secured configuration also includes verification of error-free execution of the respective processing step. For example, each functionally-secured processing step can be formed by an arithmetically encoded processor command and/or encoded data values and/or in order to verify the plausibility of a result of the processing step it is possible to check whether the result of the processing step is in a predetermined interval of permissible values. In particular, the additional test provided by the functional safety does not change the result, but only generates an additional signal to the effect that the processing step was error-free (no bit errors and/or result of the processing step within a permissible value interval) or that the processing step contained errors (bit errors, implausible result outside the value interval). In the event of errors in a processing step, the result is in particular discarded and the safe state is initiated.

The safety function in the present case has a safety sub-function. The safety sub-function is subject to the same safety requirements as the safety function. The execution of the safety sub-function can be outsourced or encapsulated. In particular, inputs of the safety sub-function are defined that are passed to it by the safety function, and outputs of the safety sub-function are defined that are supplied by it to the safety function. Furthermore, input values are transmitted, for example, directly from a sensor connected to the second safety-oriented control device to the safety sub-function. For example, the safety sub-function comprises particularly computer-intensive, complex or time-consuming program sections of the control program. The program section of the safety sub-function, for example, is subject to particularly high complexity and performance requirements. The complexity and associated high processing times arise in particular due to the safety requirement and the associated requirement for safety-oriented processing.

The safety sub-function is advantageously processed on the second safety device that function as a processor unit. This second processor unit is preferably suitably optimized for the safety-oriented processing of the complex program sections. In particular, this leaves the operation of the first safety device unchanged, in a particularly advantageous way.

The first safety device is, for example, a so-called F-PLC, i.e. a fail-safe designed programmable logic controller (PLC) for controlling apparatuses or systems or components of the system. This can be used in the usual way for less complex program sections and in particular, in the usual way, connected to fail-safe sensors and a fail-safe actuator system. The outsourcing of certain program sections to the second safety device enables flexible deployment of the control system even for applications such as safety-oriented robotics, because in this area Cartesian calculations in three-dimensional space with corresponding arithmetic, in particular trigonometric, operations are often necessary, and the use of floating-point numbers is often a requirement.

The first safety device may advantageously have a software-based mechanism for the safety-oriented execution of the safety function, which can be selected independently of the complexity of the safety function as a whole. This section of the program can only be run in a safety-oriented way if there is diversity in the configuration of the safety function on the first safety device in software. The associated advantages of software redundancy can be used, in particular the ability to be used in combination with non-safety-oriented hardware, or its scalability.

The second safety device can then advantageously be tailored and optimized to the requirements of the safety sub-function. The safety-oriented mechanism provided on the first safety device does not also need to be provided on the second safety device, instead a mechanism that is more suitable for complex control program sections is chosen for the safety-oriented processing.

In particular, a mechanism is implemented on the processor unit that implements on-chip redundancy. This means that the complex sub-function requires neither complex processing in software on diversified channels nor a completely two-channel, redundant implementation in hardware with the need for multiple PLCs. This avoids high costs due to complex individual architectures, partly also due to lack of standards, or due to manual program modifications, in which a suitable structuring of the user program must be selected. At the same time, high performance is achieved and the disadvantage of slow cycle times can be eliminated. The processor unit is understood here to mean a piece of hardware consisting of one processor, in contrast to multiple processing of the program code on hardware with more than one processor.

To ensure the safety of the system, secure communication between the safety devices is provided via a safety-oriented communication link, in particular using a secure protocol, for example, the PROFIsafe protocol. In particular, this advantageously reveals message errors during data exchange between the safety devices.

The inventive control system enables a fail-safe and high-performance processing of safety subprograms with complex safety requirements while simultaneously allowing connection to a fully user-programmable, fail-safe control system that operates with diversified processing paths.

By outsourcing the safety subprogram, resources are freed up on the coded-processing controller, which are then advantageously available for other safety or standard operations.

In accordance with one embodiment, the first safety-oriented control device is configured to execute the at least one safety function using a coded working method, in particular a “coded processing” method.

A coded processing method is based on the principle of diversified execution of software code on a processor unit. In particular, safety-relevant processing steps are performed on two diverse channels using coded data and operations, which eliminates hardware redundancy for this processing step while also providing consistency of the solution and scalability.

For example, “diversified encoding” is used, which is based on two different executions of the same safety function. These two executions are:
Native execution: The native execution corresponds to the execution of the original safety function without coding. The source code for the original safety function forms the source code of the native execution. The native execution works on native (original) input values and the native state. It only changes the native state. The result of the native execution is the native output.
Coded execution: The coded execution (using Coded Processing) is based on the coded variant of the safety function. It works on coded input values and the coded state. The result is the coded output.

Both types of execution are completely independent computations, but they operate on the same values. The coded input values are the coded variants of the native input values. The source code of the native safety function is used to create the source code of the coded execution. The code can be created either manually or, recommended for reproducibility, with an appropriate tool.

In accordance with another embodiment, the second safety-oriented control device is configured to execute the at least one safety sub-function using an uncoded working method. By using an uncoded processing method on the second safety-oriented control device, the subprogram with high performance or complexity requirements can be outsourced to a second fail-safe, high-performance control unit, e.g. via suitable on-chip hardware redundancy.

All existing tools for automation and connection of sensors and actuators can be advantageously used on the first safety-oriented control device. For execution of the complex subprogram with high performance requirements, which cannot be executed on the first safety-oriented control device with a sufficiently high cycle time or without reasonable additional effort due to the coded processing used there, the second safety-oriented control device is used as a safety coprocessor.

In particular, for calculations or program sections in which, for example, data is to be stored in arrays or created as a matrix or as a vector, common safety programs on PLCs, such as are typically used for the execution on the first safety-oriented control device, will be close to their limits. Furthermore, there are no suitable options for storing remanent data. Dynamic variables that change in the process and are stored as intermediate values, such as for more accurate estimation of positions of moving devices in industrial plants, can be advantageously deployed on the second safety-oriented control device.

The second safety-oriented control device is connected to the first safety-oriented control device via a secure protocol for communicating the relevant inputs and outputs of the subprogram. The complex subprogram can be executed with high performance on the coprocessor via all the operations available there and the results can be securely communicated back to the F-PLC.

In certain embodiments, the second safety-oriented control device is hard-coded. Advantageously, it is thus configured optimally for specific applications and hardware used, for example, by inlining or by locating certain functions in high-performance areas. Furthermore, a pre-test, in particular with certification of the specific application, is advantageously feasible.

In alternative embodiments, the second safety-oriented control device is freely programmable, so that the second safety-oriented control device can be provided in a quasi-standardized manner for a wide variety of use cases and application-specific modifications can be made by the end user, such as in the form of a safety app.

In accordance with a further embodiment, the second safety-oriented control device is configured for implementing hardware redundancy on the processor unit, in particular based on a multi-core architecture with lockstep cores. This provides on-chip redundancy, i.e., a redundant execution on a single processor unit. For example, when using lockstep cores, two or more cores execute identical code. An independent comparator compares the results and detects errors from different values during execution. For example, lockstep cores take advantage of a delay of a few clock cycles in processing identical commands, and exploit minor variations in the spatial arrangement of the cores to achieve diversification. For example, temporal and spatial distinctions are necessary to rule out errors common to the processors, i.e., common cause errors.

In accordance with another embodiment, the first safety-oriented control device is configured to receive output data from the second safety-oriented control device. For example, the output data obtained will be the results of a safety function, such as zone monitoring. For example, the second safety-oriented control device processes a safety function as a whole: For zone monitoring, the positions of a kinematic system in Cartesian space are calculated. For example, the positions are compared against defined zone boundaries. As the result, it is possible to determine whether the kinematic system is located in safety zones, so that in particular a stoppage of the kinematics must be initiated, or whether it complies with defined working zones, etc. In addition to the safety-oriented calculation of intermediate values in the safety function, such as positions, velocities, accelerations, orientations, an evaluation is advantageously also implemented as part of the processing of the safety function program as to whether violations of zones or limit values or the like are present or imminent. As a result, for example, a stop ID is then output to the first safety-oriented control device as an output data point. For example, information is also output about which response the controller should make as a whole, i.e., in what way connected actuators should be controlled. Thus, the entire calculation and analysis is advantageously performed as part of the execution of a safety function on the second safety-oriented control unit. For the purposes of outputting control commands to the actuators, for example, the first safety-oriented control device is again used. Furthermore, in such a scenario, the first safety-oriented control device is preferably also used for communication with the sensors, so that the safety coprocessor performs the complex safety-relevant calculations virtually invisibly from the perspective of the peripherals. Furthermore, in some embodiments only information about results obtained or measures initiated by the second safety-oriented control device is provided as the output for the first safety-oriented control unit. In particular, a particularly high throughput is thus achieved.

In accordance with another embodiment, the first safety-oriented control device is configured to process output data received from the second safety-oriented control device via the safety-oriented communication link for executing the at least one safety function. In accordance with the presently contemplated embodiment, an intermediate value that is required in a safety function is calculated and delivered by the second safety-oriented control device. For example, values for positions, velocities, accelerations and/or orientations, are provided, which are then further processed as part of an execution of the safety function on the first safety-oriented control device. For example, this enables complex calculations involving trigonometric functions or the use of floating-point numbers on the coprocessor, and only values that can also be further processed easily in coded form are returned to the safety PLC working with Coded Processing.

Furthermore, the occupation of a safe state is initiated by the first safety-oriented control device, if, for example, a system error or fault state of the first safety-oriented control device is determined by the first safety-oriented control device via the coding-based diversified program processing.

In accordance with yet another embodiment, the second safety-oriented control device is configured to initiate a safety measure depending on a result of the safety sub-function. The initiation of a safety measure in some embodiments is performed directly by the second safety-oriented control device.

For this purpose, actuators, in particular only a specific portion of the actuators, can be directly connected to the second safety-oriented control device. For example, special drives that cause the movement of a kinematics system in three-dimensional space can be directly activated by the controller of the coprocessor. Emergency stops are thus implemented directly in a particularly advantageous manner and without delay through communication channels, etc.

The second safety-oriented control device is further configured to detect a system error due to the diversified execution of the program code. Advantageously, in the case in which a corrupt system behaviour is detected, such as a failure of a component such as a sensor, or some other type of system error, a safety measure is initiated by the second safety-oriented control device, which causes the system to occupy a safe state. For example, values are specified directly to the actuators, which lead to the occupation of the safe state.

In accordance with another embodiment, the first safety-oriented control device is configured to initiate a safety measure depending on output data received via the safety-oriented communication link. The introduction of safety measures by the first safety-oriented control device is then effected via the actuators connected to the first safety-oriented control device without the second safety-oriented control device being visible to the actuator. For example, stoppages are initiated when calculations in the context of the execution of the safety function on the first safety-oriented control device result in zone violations or limit violations or when information on a stoppage to be initiated, in particular a stop ID, is supplied by the second safety-oriented control device. Furthermore, the occupation of a safe state is initiated by the first safety-oriented control device, if, for example, a system error or fault state of the second safety-oriented control device is determined by the second safety-oriented control device.

The initiation of the safety measure may in turn consist of entering a safe state due to a detected system error. The second safety-oriented control device then delivers, for example, substitute values to the first safety-oriented control device, or communication with the first safety-oriented control device is disabled. The first safety-oriented control device then continues to run in some embodiments, as an error was only detected on the second safety-oriented control device. In alternative embodiments, as a precaution, the first safety-oriented control device also initiates the occupation of a safe state, because the substitute values are considered insufficient for the functional safety of the system.

The objects and advantages are further achieved in accordance with the invention by a method for controlling an apparatus or system, where the apparatus or system is controlled via at least one safety function, where the at least one safety function has at least one safety sub-function, where the control system comprises a first safety-oriented control device and a second safety-oriented control device, where the first safety-oriented control device and the second safety-oriented control device exchange data via a safety-oriented communication link, where the first safety-oriented control device executes the at least one safety function, and where the second safety-oriented control device functions as a processor unit and executes the at least one safety sub-function using received input data.

In accordance with one embodiment, the first safety-oriented control device executes the at least one safety function using a coded working method, in particular a “Coded Processing” method.

In accordance with another embodiment, the second safety-oriented control device executes the at least one safety sub-function using an uncoded working method.

In accordance with a further embodiment, the second safety-oriented control device implements hardware redundancy on the processor unit, in particular based on a multi-core architecture with lockstep cores.

In accordance with another embodiment, the first safety-oriented control device receives output data from the second safety-oriented control device.

In accordance with a still further embodiment, the first safety-oriented control device processes output data received from the second safety-oriented control device via the safety-oriented communication link for executing the at least one safety function.

In accordance with another embodiment, the second safety-oriented control device initiates a safety measure depending on a result of the safety sub-function.

In accordance with one embodiment, the first safety-oriented control device initiates a safety measure depending on output data received via the safety-oriented communication link.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is explained in more detail below on the basis of exemplary embodiments with reference to the figures, in which:

FIG. 1 shows a schematic illustration of components of the control system in accordance with a first exemplary embodiment of the invention;

FIG. 2 shows a schematic illustration of components of the control system in accordance with a second exemplary embodiment of the invention;

FIG. 3 shows a schematic illustration of components of the control system in accordance with a third exemplary embodiment of the invention;

FIG. 4 shows a schematic illustration of components of the control system in accordance with a fourth exemplary embodiment of the invention; and

FIG. 5 is a flowchart of the method in accordance with the invention.

### DETAILED DESCRIPTION OF THE EXEMPLARY EMBODIMENTS

In the figures, elements having the same function are provided with the same reference signs, unless stated otherwise.

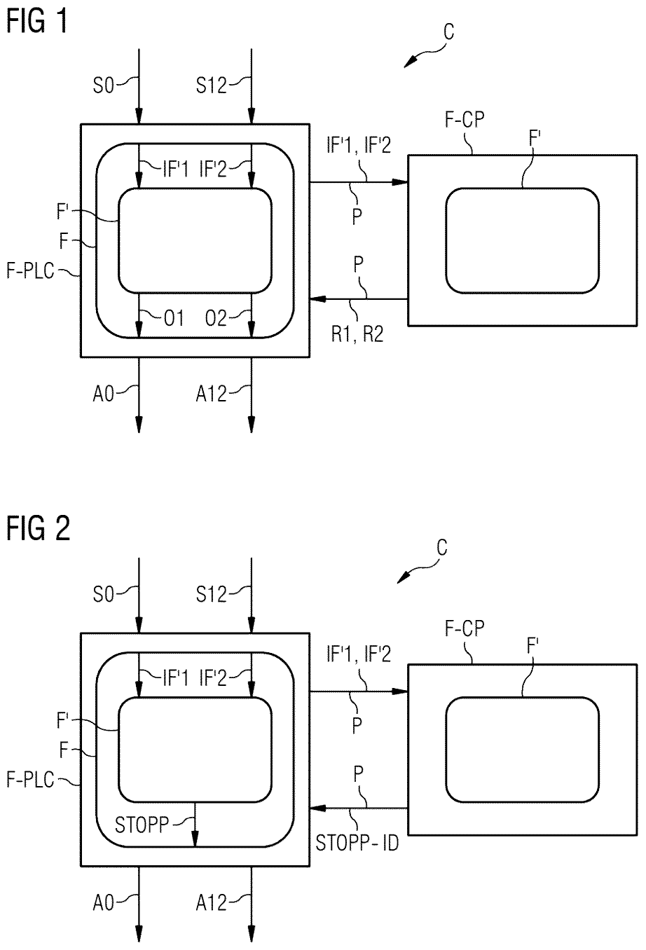

FIG. 1 shows a first exemplary embodiment, in which in a control system C for a system with motion-controlled components a first safety-oriented control device is provided, in particular a failsafe PLC (F-PLC), on which control program code is executed in a safety-oriented manner using a coded processing method. The control program code is executed in software in a diversified manner, so that the probability of undetected system errors or execution errors is sufficiently low to comply with the requirements on the safety of the system.

The first exemplary embodiment relates to a system in which gripper arm robots are used and intrude into areas in which human beings are active. Accordingly, the control system C is subject to safety requirements that ensure safety-oriented monitoring of the movements, where the appropriate initiation of safety measures depends on the movement pattern or trajectory, the provision of emergency stop procedures, etc.

A safety user program is created on the failsafe PLC F-PLC, which implements the safety requirements and has a safety function F. The safety function F comprises in particular a plurality of safety function blocks that define how the drives should respond to the actuation of emergency stop switches or how axial safety functions are parameterized. For example, an axial speed monitoring, axial force monitoring and axial torque monitoring is provided in a safety function block of the safety function F, in which limit values are specified for the respective variables. For example, a limiting torque is specified for each axis, and the kinematics initiates a stoppage when this is exceeded.

For example, the speed of an end effector moving in the Cartesian space should also be reduced when it approaches the area of a safety zone that it is not allowed to enter. For example, a stoppage should also be initiated when it reaches the zone boundary.

For this type of safety monitoring, the current position of the robot and its axis segments in space is determined and compared with defined spatial regions specified by zones. This requires calculations that are based, for example, on trigonometric relationships between axes of the kinematics system. Furthermore, parameters are specified that describe the kinematics or properties of the kinematics, for example dimensions or movement radii. These forms of information are plant-specific or machine manufacturer-specific and therefore cannot normally be manipulated individually or by a plant operator. The values that are specified as parameters can therefore often only be described by floating point numbers.

This functionality with complex calculations based on arithmetic operations is encapsulated in a safety sub-function F′ and outsourced for execution as a modular software module to the second safety-oriented control device as the safety coprocessor F-CP.

The safety user program for operating the robot is programmed on the failsafe PLC F-PLC. The sensor system SO, S12 is also connected to the failsafe PLC F-PLC and delivers values for positions, velocities, switch states, etc.

Safe inputs IF′1, IF′2 for the safety sub-function, such as in particular axis values of encoders that are required for executing the safety sub-function, are transmitted from the failsafe PLC F-PLC to the safety co-processor F-CP via a secure communication link P, in particular based on a safe telegram, for example in accordance with the PROFIsafe standard. Furthermore, data from the safety co-processor F-CP is returned to the failsafe PLC F-PLC via the secure communication link P as results R1, R2.

In accordance with the first exemplary embodiment, the safety sub-function F′ determines values for variables such as position and velocity in Cartesian space from dimensions of the kinematics, axis values of the individual axes of the kinematics or axial error values. These values are calculated using trigonometric relationships and based on input values that include floating point numbers. For this calculation, the uncoded execution is advantageously provided on the safety coprocessor F-CP, on which the safety-oriented execution is based on hardware redundancy by means of lockstep processors. This makes it possible to implement the arithmetic operations simply without auxiliary recalculations that would be necessary for coded processing such as Coded Processing.

The results R1, R2 of the safety sub-function F′ are further processed on the safety coprocessor F-CP by the safety function F. For example, a position of the end effector is returned to the failsafe PLC F-PLC, a subsequent adjustment, which includes the violation of limit values or the intrusion into restricted zones, and the output of corresponding results O1, O2 of the adjustment, occurs on the F-PLC.

The failsafe PLC F-PLC is also connected to actuators A0, A12, for example, to the drives of the axes, for the implementation of the responses. Within the scope of the safety function F, responses are specified that should occur in the event of violations of specified limits, such as the conditions for disabling drives. The adjustment of values determined both via the safety function F and via the safety sub-function F′ with specified limit values is thus performed in accordance with the first exemplary embodiment on the failsafe PLC F-PLC.

The failsafe PLC F-PLC is to be regarded as the main loop of the safety program and is quasi the main point of contact for the kinematics. The safe sensors S0, S12 are also connected to the failsafe PLC F-PLC.

Sensors S0 and actuators A0 are provided, which supply values at inputs and receive values supplied at outputs, independently of the processing on the safety coprocessor F-CP.

In accordance with a second exemplary embodiment, the safety coprocessor F-CP receives all the required data, in particular the axis positions of all the axes involved, via defined interfaces. In particular, associated counter values or time stamps are also transferred, in order to ensure the comparability of the various axis values and to be able to take into account time delays in the provision or transmission.

For example, in a safe motion monitoring system, the user also selects which zones of a zone monitoring system are active or which cones are monitored. This is implemented via interfaces to the user program on the failsafe PLC.

Input data relating to the safety sub-function F′ is quasi transferred from the safety function F to the safety sub-function F′ and transmitted to the safety coprocessor F-CP via a secure communication link P.

For example, the safety coprocessor is a multi-core processor with a plurality of safety cores. A dual-core processor is installed on the safety coprocessor F-CP for each safety core, which performs data processing according to the lockstep mechanism. A “master” and “checker” calculate the same steps, only on geometrically slightly offset cores of the processor, for example, slightly rotated and with different temporal constraints, so that an error that propagates through both paths does not lead to the same results for the two cores. If the results of both calculations on the dual-core processor match, then the result is recognized as correct and further processed by the safety sub-function F′.

FIG. 2 illustrates that the safety coprocessor F-CP delivers an identifier for a stop operation as the result STOP-ID of the safety sub-function F′. The safety sub-function F′ therefore not only delivers values for further processing by the safety function F of the failsafe PLC F-PLC, but also delivers a result STOP-ID, which can be passed from the safety function F directly to an actuator A12 as the output STOP. This directly causes a drive, for example, to stop.

For example, in embodiments, the safety function F determines which action is initiated in the event of a STOP-ID result of the safety sub-function F′. Thus, although the STOP-ID result is not processed further, via the safety function F a user specifies an assignment of the results of the safety sub-function F′ to measures initiated by the failsafe PLC F-PLC.

The outputs of the safety sub-function F′ described so far are the results obtained when the calculations are executed correctly and without errors on the safety coprocessor F-CP. These can be results that describe the violation or non-violation of limits or zones, as described above as raw values or intermediate values that are further processed on the failsafe PLC, or even as final results of a safety function block with correspondingly possible direct output of a programmed response to an actuator in the event of a violation of zones or limit values.

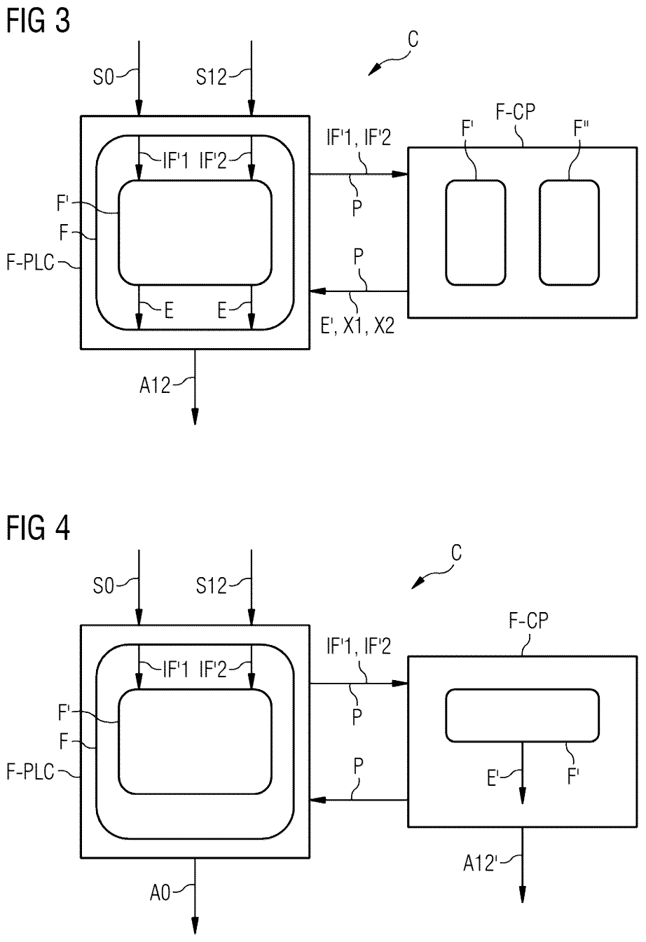

FIG. 3 illustrates a third exemplary embodiment in which an error E′ is detected on the safety coprocessor F-CP. For example, a hardware failure is detected in one of the processor cores, or some other type of failure is detected in a semiconductor device of the processor.

As a result, the safety coprocessor F-CP returns an indication of the system error E′ to the failsafe PLC F-PLC. Substitute values X1, X2 are also supplied, which are used to detect that there is a “stop”. Since in the fault state it is not guaranteed that the safety co-processor F-CP is still intact, communication is interrupted for safety and the safe substitute values are applied.

For example, a plurality of safety sub-functions F′, F″ run on the safety coprocessor F-CP. If a system error E′ is detected on the safety coprocessor F-CP, all applications that are executed by the safety sub-functions F′, F″ are interrupted. The failsafe PLC F-PLC continues to run, but initiates safe states E for all processes or actions that depend on the results of one of the safety sub-functions F′, F″.

For example, the safety coprocessor F-CP implements safe motion monitoring as the first safety sub-function F′ and safe force monitoring as the second safety sub-function F″. The safety coprocessor F-CP, for example, is freely programmable and enables the execution of any complex safety-relevant subprograms defined by the user. By outsourcing the subprogram, resources are freed up on the coded-processing controller that are then advantageously available for other safety or standard operations.

In accordance with a fourth exemplary embodiment, safe person detection in the industrial environment via Real Time Locating Systems (RTLS) is executed on the safety coprocessor F-CP as safety sub-function F′. In particular, for stop operations of moving machine parts or of autonomous mobile robots (AMR) in cases where people are close by, secure localization in real time is a requirement, such as in factories, production halls or warehouses.

FIG. 4 illustrates the fourth exemplary embodiment. The outsourcing of the safety sub-function F′ to the safety coprocessor F-CP for the purposes of the uncoded execution is performed in accordance with one of the above-described examples. A result of the safety sub-function F′ when executed correctly, i.e., as long as the safety coprocessor safely executes the program code without errors, is also returned to the failsafe PLC F-PLC following one of the above-described examples.

The safety coprocessor is not freely programmable, so that software and hardware are optimized together for the execution of the RTLS functionality.

If a system error is detected during the safety-oriented execution of the program code on the safety coprocessor F-CP, only a diagnostic message is output to the failsafe PLC F-PLC. The communication of result values is prevented via the secure communication link P. The measures for entering a safe state of moving components due to a person being detected in the environment of the components are initiated directly by the safety coprocessor F-CP. For this purpose, it is directly connected to actuator A12′ and the output of a detected system error E′ leads, for example, to a safe stop of a robot gripper arm or an AMR. The failsafe PLC F-PLC is merely informed that a stoppage has been initiated. The failsafe PLC F-PLC itself is also connected to actuator A0 and initiates responses depending on the result of safety functions F executed on the failsafe PLC F-PLC.

Due to the direct interconnection of the safety coprocessor F-CP to the actuator A12′, a particularly fast reaction in the safety-critical environment with real-time requirements is necessary to disable the corresponding drives.

In embodiments, sensors can also be directly connected to the safety coprocessor F-CP in order to ensure particularly high response times.

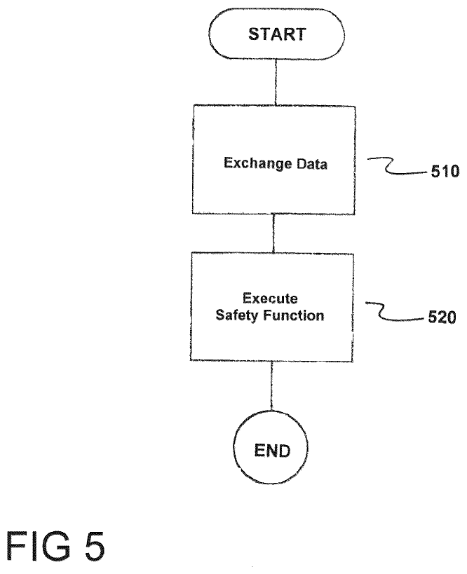

FIG. 5 is a flowchart of the method for controlling an apparatus or system, where the apparatus or system is controlled via at least one safety function F, the at least one safety function F has at least one safety sub-function F′, and the control system C comprises a first safety-oriented controller F-PLC and a second safety-oriented controller F-CP.

The method comprises exchanging data between the first safety-oriented controller F-PLC and the second safety-oriented controller F-CP via a safety-oriented communication link P, as indicated in step 510.

Next, the first safety-oriented controller F-PLC executes the at least one safety function F, as indicated in step 520.

In accordance with the invention, the second safety-oriented controller F-CP function as a processor and executes the at least one safety sub-function F′ utilizing received input data IF′1, IF′2.

In summary, a first safety-oriented control device with coded working serves as a basis for connecting to the automation environment and is in particular freely programmed by the user. The advantages in terms of consistency and scalability, for example, of coded processing, are fully exploited. Complex calculations in program code, which in particular are not possible at all, or only slowly or with enormous manual effort, with programming languages of common failsafe PLCs, such as F-FUP or F-KOP, are executed on the second safety-oriented control device as a safety sub-function and enable the implementation of complex functions. These include, for example, inverse operations, the use of floating point numbers, and/or sine or root functions. The safety subprogram runs uncoded on the coprocessor using suitable hardware redundancy and implements performance-critical program components.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A control system for controlling an apparatus or system, at least one safety function being provided with regard to control of the apparatus or system, and the at least one safety function having at least one safety sub-function, the control system comprising:
a first safety-oriented controller; and
a second safety-oriented controller;
wherein the first and second safety-oriented controllers are communicatively coupled via a safety-oriented communication link;
wherein the first safety-oriented controller is configured to execute the at least one safety function; and
wherein the second safety-oriented controller functions as a processor and is configured to execute the at least one safety sub-function utilizing input data received via the safety-oriented communication link from the first safety-oriented controller.

2. The control system as claimed in claim 1, wherein the first safety-oriented controller is further configured to execute the at least one safety function utilizing a coded working method.

3. The control system as claimed in claim 2, wherein the coded working method comprises a “coded processing” method.

4. The control system as claimed in claim 1, wherein the second safety-oriented controller is further configured to execute the at least one safety sub-function utilizing an uncoded working method.

5. The control system as claimed in claim 2, wherein the second safety-oriented controller is further configured to execute the at least one safety sub-function utilizing an uncoded working method.

6. The control system as claimed in claim 1, wherein the second safety-oriented controller is configured to implement hardware redundancy on the processor, based on a multi-core architecture with lockstep cores.

7. The control system as claimed in claim 1, wherein the first safety-oriented controller is configured to receive output data from the second safety-oriented controller.

8. The control system as claimed in claim 1, wherein the first safety-oriented controller is configured to process output data received from the second safety-oriented controller via the safety-oriented communication link to execute the at least one safety function.

9. The control system as claimed in claim 1, wherein the second safety-oriented controller is configured to initiate a safety measure depending on a result of the safety sub-function.

10. The control system as claimed in claim 1, wherein the first safety-oriented controller is configured to initiate a safety measure depending on output data received via the safety-oriented communication link.

11. A method for controlling an apparatus or system, the apparatus or system being controlled via at least one safety function, the at least one safety function having at least one safety sub-function, and the control system comprising a first safety-oriented controller and a second safety-oriented controller, the method comprising:
exchanging data between the first safety-oriented controller and the second safety-oriented controller via a safety-oriented communication link; and
executing, by the first safety-oriented controller, the at least one safety function;
wherein the second safety-oriented controller function as a processor and executes the at least one safety sub-function utilizing received input data.

12. The method as claimed in claim 11, wherein the first safety-oriented controller executes the at least one safety function utilizing a coded working method.

13. The method as claimed in claim 12, wherein the coded working method comprises a “coded processing” method.

14. The method as claimed in claim 11, wherein the second safety-oriented controller executes the at least one safety sub-function utilizing an uncoded working method.

15. The method as claimed in claim 12, wherein the second safety-oriented controller executes the at least one safety sub-function utilizing an uncoded working method.

16. The method as claimed in claim 11, wherein the second safety-oriented controller implements hardware redundancy on the processor unit, based on a multi-core architecture with lockstep cores.

17. The method as claimed in claim 11, wherein the first safety-oriented controller receives output data from the second safety-oriented controller.

18. The method as claimed in claim 11, wherein the first safety-oriented controller processes output data received from the second safety-oriented controller via the safety-oriented communication link to execute the at least one safety function.

19. The method as claimed in claim 11, wherein the second safety-oriented controller initiates a safety measure depending on a result of the safety sub-function.

20. The method as claimed in claim 11, wherein the first safety-oriented controller initiates a safety measure depending on output data received via the safety-oriented communication link.

21. The method as claimed in claim 11, wherein the received input data are received via the safety-oriented communication link from the first safety-oriented controller or via a sensor connected to the second safety-oriented controller.
